(19) United States
(12) Patent Application Publication
(10) Pub. No.: US 2014/0132271 A1
(43) Pub. Date: May 15, 2014

(54) APPARATUS AND METHOD FOR DEEP RESISTIVITY MEASUREMENT USING COMMUNICATION SIGNALS NEAR DRILL BIT

(71) Applicant: GREATWALL DRILLING COMPANY, Beijing (CN)

(72) Inventors: Naizheng Liu, Beijing (CN); Qihui Zhao, Beijing (CN); Yuzhou Lu, Beijing (CN); Rui Bai, Beijing (CN); Jing Li, Houston, TX (US); Ce Liu, Sugar Land, TX (US); Yonghe Li, Beijing (CN)

(73) Assignee: GREATWALL DRILLING COMPANY, Beijing (CN)

(21) Appl. No.: 13/672,889

(22) Filed: Nov. 9, 2012

(51) Int. Cl. G01V 3/08

(52) U.S. Cl. CPC G01V 3/083
USPC 324/338

(57) ABSTRACT

An apparatus for utilizing a pre-existing telemetry transmitter near a drill bit for transmitting or receiving signals to make measurements of surrounding formation resistivity includes a drill collar, at least two toroidal receiving antennas deployed on the drill collar and spaced at an axial distance from each other for receiving or transmitting signals from or to the telemetry transmitter, at least two receiver modules coupled to the toroidal receiving antennas for processing signals received or to be transmitted from or to the telemetry transmitter and adjusting frequency the receiver modules work at, and a converting module coupled to the receiver modules. The converting module includes a microprocessor for calculating the surrounding formation resistivity and controlling the frequency tuners in the receiver modules. A corresponding method for utilizing a multiple dimensional conversion chart to convert data of measured flow-out current through the formation into data of formation resistivity is also provided.

### FIELD OF THE INVENTION

The present invention relates generally to the field of electrical resistivity well logging. More particularly, the invention relates to an apparatus and a method for making resistivity measurements of a subterranean formation adjacent the wellbore.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, the resistivity is an important parameter in delineating hydrocarbon (such as crude oil or gas) and water contents in the porous formation. It is preferable to keep the borehole in the pay zone (the formation with hydrocarbons) as much as possible so as to maximize the recovery.

A conventional bottom hole drilling assembly (“BHA”) 100 can include a drill bit 114, an at-bit sensor unit 110, one or more stabilizer 104, a mud motor 108, a LWD sensor system 106, and a drill collar 102 as shown in FIG. 1 as part of a drilling string for drilling operation. The at-bit sensor unit 110 can include compact sensors necessary for the driller to monitor and guide the drilling, for example, a bit orientation sensor, Gamma ray reader, and a telemetry transmitter 112, for sending at-bit information to LWD system 106. The mud motor 108 is for driving the drill bit 114 during drilling operation. The LWD system 106 can include various types of logging tools, such as a resistivity tool, an acoustic tool, a neutron tool, a density tool, a telemetry system. The telemetry system, i.e. a mud pulse telemetry system, can establish a communication link from the LWD system to the surface (not shown in FIG. 1), being a relay for the at-bit information or other measured data to be sent to the surface.

The at-bit information can include information in regards to environmental conditions of a surrounding subterranean near the drill bit 114, which becomes important operational and directional parameters for the driller to adjust its direction in wellbore drilling on a real time basis.

Accordingly, several short hop transmitting systems have been developed for sending the at-bit information to the LWD system 106 and then communicating with the surface through the telemetry unit in LWD system 106 to optimize the drilling operation. For instance, a wireline cable system can be installed with the BHA to transmit information from the at-bit sensors in downhole to the LWD system 106. However, this hard-wire system is easily subject to damages during operation. Furthermore, a wireless transmission system is another option. The wireless transmission system can transmit electromagnetic signals or acoustic or seismic signals through the drill string and surrounding formation.

FIG. 2A illustrates one of the wireless solutions. A voltage source 204 is applied to a collar section 200 which has a first portion 210 and a second portion 212 separated by an insulating gap 202. The applied voltage generates a potential bias between the first portion 210 and the second portion 212 and produces an axial current 206 on the collar section 200 that returns through surrounding formation as a returning current 208. However, the insulating gap 202, which mechanically creates an electrical discontinuity in the collar section 200, may cause some problems to the structural integrity of the collar section 200 resulting in a weakening of the drilling string at the insulating gap 202.

FIG. 2B illustrates another solution. A collar section 200 is deployed with a toroidal transmitter 214 near the bit. The transmitter 214 transmits or receives electromagnetic signals for short hop communication with the LWD system. Furthermore, the axial current 206 is induced in the collar section 200 which returns through surrounding formation as the returning current 208. Utilizing the toroidal transmitter 214 can avoid possible damage caused by “gap-type” transmitter. FIGS. 2A and 2B illustrate two types of existing short hop transmitters employed to send the at-bit information to the LWD system 106. Besides the communication functionality, these at-bit transmitters may have potential for more applications, such as formation resistivity measurement. FIG. 3 shows an example of an apparatus that employs toroidal transmitters and receivers for formation resistivity measurements. A BHA (button hole drilling assembly) 300 may include a collar 302, a resistivity tool 304, a downhole motor 306, and a drilling bit 308. The resistivity tool 304 includes a transmitter array with multiple toroid transmitters T1, T2, and T3 and a pair of toroid receivers R1 and R2 coaxially mounted on the collar 302 and positioned above the downhole motor 306 for surrounding formation resistivity measurements. Each toroid transmitter T1, T2, or T3 has a different offset from the midpoint of the pair of toroid receivers R1 and R2 to obtain multiple depths of investigation. When any of the transmitters energizes, an axial current can be induced in the resistivity tool 304 along the collar 302. The axial current propagating along the collar 302 can be measured at the toroid receivers R1 and R2 respectively, denoted as I₁ and I₂. The formation resistivity around the resistivity tool 304 can be computed according to the measured I₁ and I₂ at the toroid receivers R1 and R2 by Ohm's law,

$$R = k \frac{{V}_{m}}{I} \qquad ( 1 )$$

Where R is the resistivity of surrounding formation. I is the measured current by the receivers; k is the tool's geometrical factor dependent on the spacing of toroids and tool dimensions; Vₘ is the applied excitation voltage to the transmitter.

However, the above resistivity tool 304 shall be positioned above the downhole motor 306 for the concern of limited space around the drilling bit 308. As a result, the resistivity tool 304 may have a lag on measurements of environmental conditions around the drilling bit 308 (the distance between the drilling bit 308 and the resistivity tool 304 could be 30 feet or more). Also, the resistivity tool 304 requires both toroid transmitters T1, T2, or T3 and a pair of toroid receivers R1 and R2 to conduct measurements.

As described above, a need exists for an improved apparatus and method for measurements of environmental conditions of formation around a drill bit.

A further need exists for an improved apparatus and method for measurements of resistivity of surrounding formation utilizing a pre-existing sensor as a transmitter around the drill bit.

The present embodiments of the apparatus and the method meet these needs and improve on the technology.

### SUMMARY OF THE INVENTION

This section provides a general summary of the disclosure, and is not a comprehensive disclosure of its full scope or its entire feature.

In one preferred embodiment, an apparatus for utilizing a pre-existing telemetry transmitter mounted on a drilling string and positioned below a mud motor and near a drill bit for transmitting or receiving signals to make measurements of surrounding resistivity conditions includes a drill collar, at least two toroidal receiving antennas deployed on the drill collar and spaced at an axial distance from each other for receiving or transmitting signals from or to the telemetry transmitter, at least two receiver modules coupled to the toroidal receiving antennas, a converting module coupled to the receiver modules. The signals include difference between electrical signals measured at the two toroidal receiving antennas. The receiver modules include electrical modules for processing signals received or to be transmitted from or to the telemetry transmitter and frequency tuners to adjust the frequency that the receiver modules work at so as to match the frequency that the pre-existing at-bit transmitter works at. The converting module includes a microprocessor for calculating the surrounding formation resistivity and controlling the frequency tuners in the receiver modules.

In some embodiments, the signals are electrical signals or electromagnetic signals.

In some embodiments, the electrical signals include an axial current on the drill collar.

In some embodiments, the electrical module includes an electrical corresponding circuitry configured to process the signals from the telemetry transmitter and relays signals to the microprocessor in the converting module for calculating the surrounding formation resistivity.

In some embodiments, the converting module includes a telemetry module with a telemetry corresponding circuitry to communicate with an operator at surface.

In some embodiments, the operator at surface transmits signals about frequency information for matching the frequency of the telemetry transmitter, via the telemetry module to direct the frequency tuner to adjust frequency the receiver modules work at.

In other embodiments, the apparatus further includes a frequency sweeping device coupled to a transmission link between the toroidal receiving antenna and the receiver module, and a frequency estimator coupled to the frequency sweeping device.

In other embodiments, the frequency sweeping device includes a frequency sweeping corresponding circuitry configured to determine the frequency spectrum in an operable frequency band of the telemetry transmitter by reading the magnitude of signals in a series of frequencies.

In other embodiments, the frequency estimator includes a frequency estimator corresponding circuitry configured to choose frequency from the frequency spectrum by identifying the frequency with a maximum magnitude among a series of frequencies.

In other embodiments, the receiver modules include electromagnetic modules including electromagnetic corresponding circuitry configured to process the signals to or from the telemetry transmitter for gathering information of environmental conditions except for the surrounding formation resistivity.

In other embodiments, the converting module includes a storage device.

In another embodiment, the storage device is stored with a multiple dimensional conversion chart with dimensions of the formation resistivity, a signal frequency, a spacing between the telemetry transmitter and the pair of toroidal receiving antennas, and measured signals for computing the surrounding formation resistivity according to the inputted data of the signal frequency, the spacing between the telemetry transmitter and the pair of toroidal receiving antennas, and the measured signals.

In another embodiment, the measured signals are measured flow-out current through the formation between the two toroidal receiving antennas, which is equal to the difference in axial current measured at the two toroidal receiving antennas.

In another embodiment, the bandwidth of the signal frequency of the toroidal receiving antenna covers whole frequency band that is practical for the telemetry transmitter to operate.

In one preferred embodiment, the method for utilizing a multiple dimensional conversion chart to convert a data of measured flow-out current through the formation into a data of formation resistivity on an apparatus with a telemetry transmitter and a pair of toroidal receiving antennas includes building a multiple dimensional conversion chart, detecting the signal frequency, measuring the flow-out current through formation between the two toroidal receiving antennas, and converting the data of measured flow-out current into the data of formation resistivity by checking the pre-built multiple dimensional conversion chart. The multiple dimensional conversion chart includes dimensions of the signal frequency, the spacing between the telemetry transmitter and the pair of toroidal receiving antennas, the formation resistivity, and the flow-out current through formation between the two toroidal receiving antennas

In some embodiments, the receiving signal frequency includes receiving the signal frequency from an operator at surface.

In some embodiments, the receiving signal frequency includes receiving the signal frequency from a frequency estimator, which determines frequency according to a transmitting frequency spectrum in an operable frequency band of the telemetry transmitter.

In some embodiments, the measuring the flow-out current includes calculating the difference in axial current measured at the two toroidal receiving antennas.

In another embodiment, the converting the data of measured flow-out current into the data of formation resistivity includes gathering information of the measured flow-out current, the signal frequency, and the spacing between the telemetry transmitter and the pair of toroidal receiving antennas to compute the data of formation resistivity.

In another preferred embodiment, an apparatus for making measurements of surrounding formation resistivity includes a drill collar, a telemetry transmitter deployed on the drill collar for transmitting or receiving signals, at least two toroidal receiving antennas deployed on the drill collar for receiving or transmitting signals from or to the telemetry transmitter, at least two receiver circuits coupled to the toroidal receiving antennas, at least two frequency tuners coupled to the receiver circuits to adjust frequency which the receiver circuits work at, and a converting module coupled to the receiver circuits for calculating the surrounding formation resistivity, controlling the frequency tuners, and being stored with a multiple dimensional conversion chart for computing the surrounding formation resistivity.

The signals include difference between electrical signals measured at the two toroidal receiving antennas.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1 illustrates a prior art of a conventional bottom hole drilling assembly (“BHA”) as a part of a drilling string.

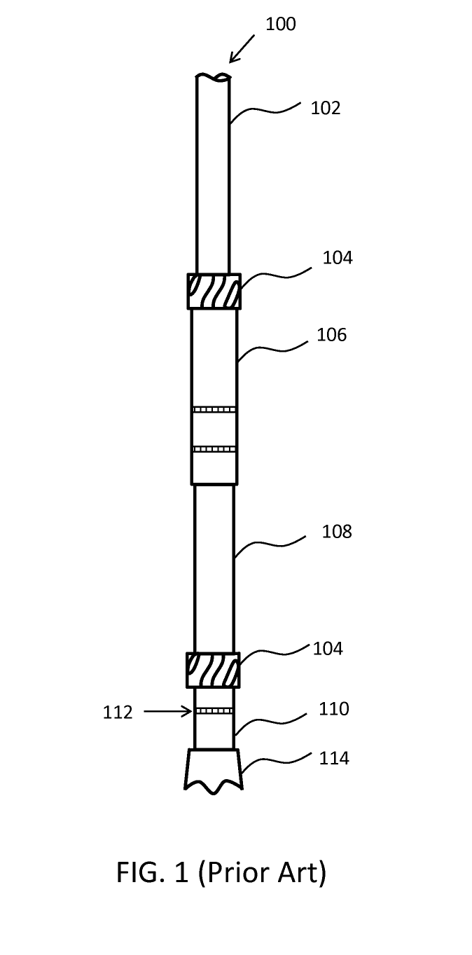

FIG. 2A illustrates a prior art of a gap-type transmitter for at-bit short-hop telemetry using a voltage source across an insulating gap to generate an axial current along the drill collar to send the at-bit information across the mud motor to the LWD system.

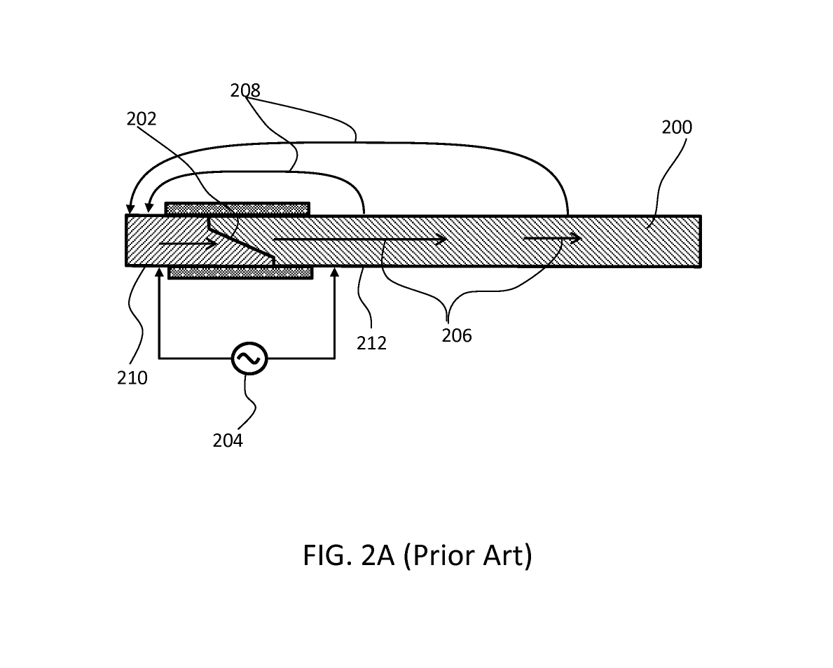

FIG. 2B illustrates a prior art of a toroidal transmitter to generate an axial current along the drill string to send the at-bit information across the mud motor to the LWD system.

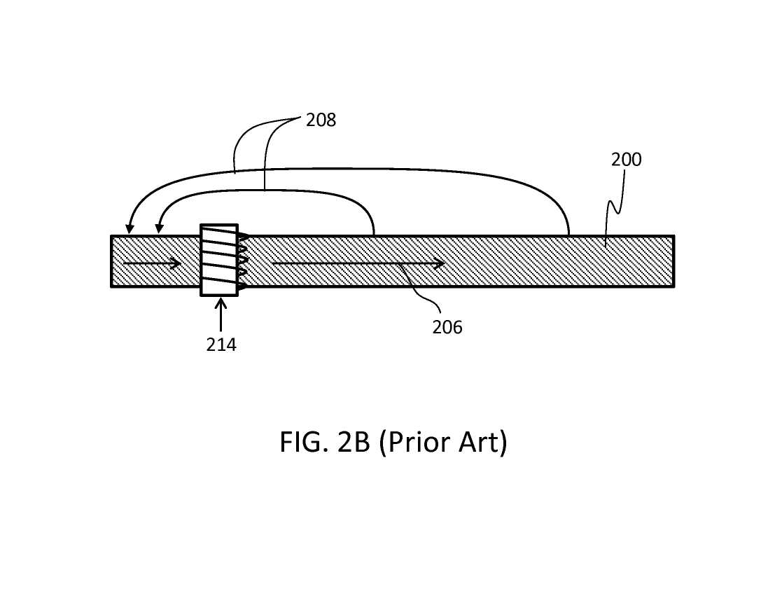

FIG. 3 illustrates a prior art of resistivity measurement system utilizing toroid transmitters and receivers mounted on a collar and positioned above a downhole motor for formation resistivity measurements.

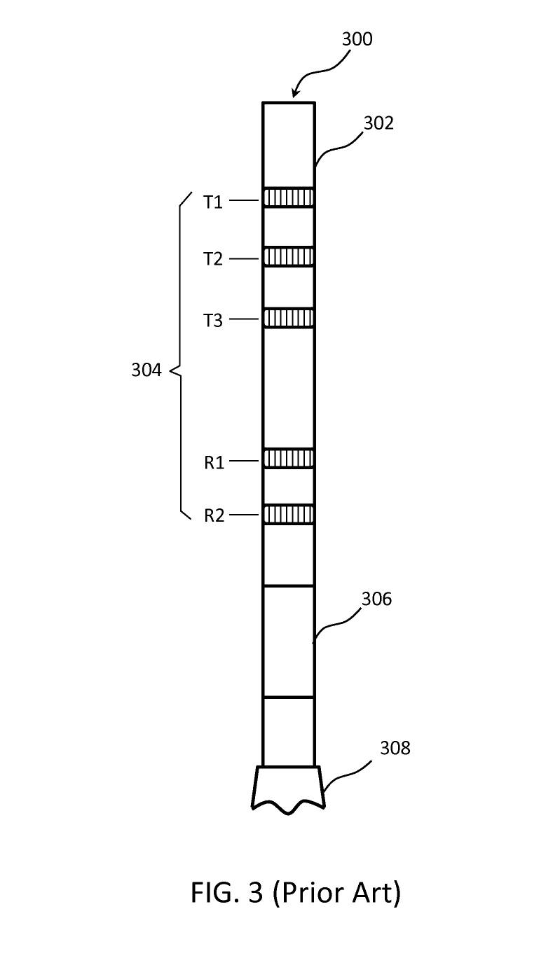

FIG. 4A illustrates a perspective view of using a pre-existing telemetry transmitter and a pair of toroidal receiving antennas coupled with a pair of receiver modules and a converting module for formation resistivity measurements according to some embodiments of the present invention.

FIG. 4B illustrates a block diagram of illustrative electronics for the receiver module according to some embodiments of the present invention.

FIG. 4C illustrates a block diagram of illustrative electronics for the converting module according to some embodiments of the present invention.

FIG. 4D illustrates a perspective view of using a pre-existing telemetry transmitter and a pair of toroidal receiving antennas coupled with a pair of receiver circuits, which are coupled to frequency tuners, and a converting module for formation resistivity measurements according to some embodiments of the present invention.

FIG. 5 illustrates a perspective view of a pre-existing telemetry transmitter and a pair of toroidal receiving antennas coupled with a pair of receiver modules, a converting module, a frequency sweeping device, and a frequency estimator, for formation resistivity measurements according to other embodiments of the present invention.

FIG. 6 illustrates a flow chart of utilizing a multiple dimensional conversion chart to convert data inputted into the formation resistivity according to some embodiments of the present invention.

FIG. 7 illustrates modeling results in term of a data graph of current ratio versus formation resistivity according to some embodiments of the present invention.

The present embodiments are detailed below with reference to the listed Figures.

### DETAILED DESCRIPTION OF THE EMBODIMENTS

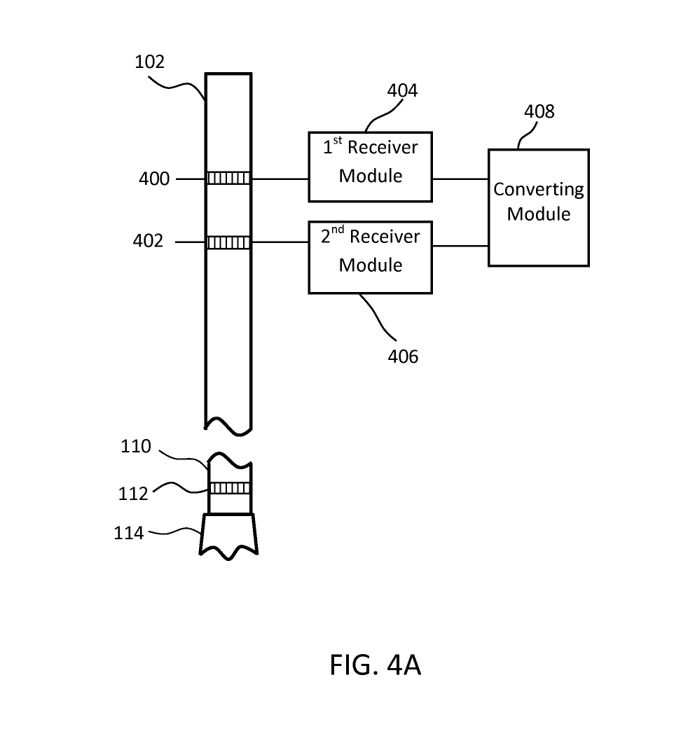

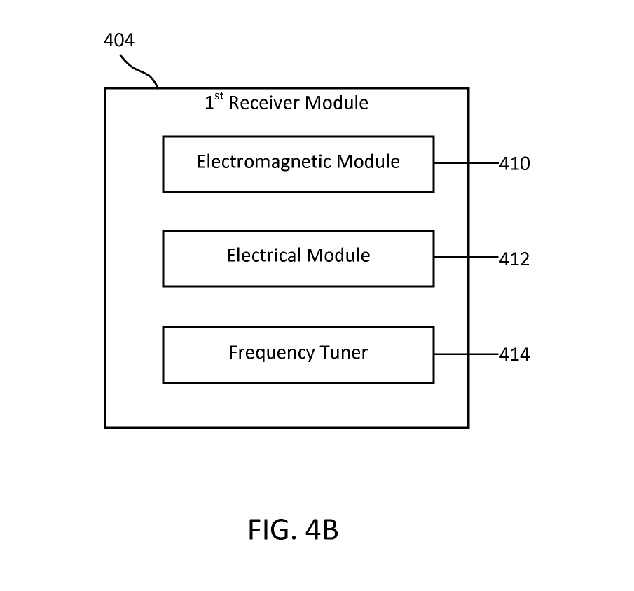

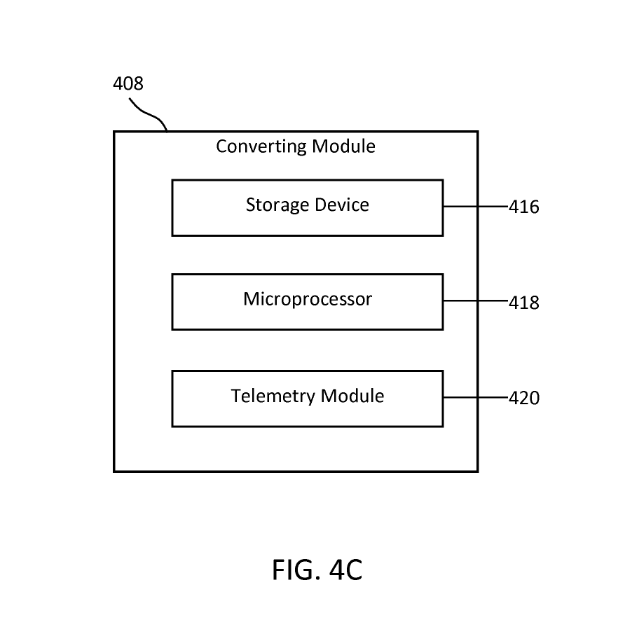

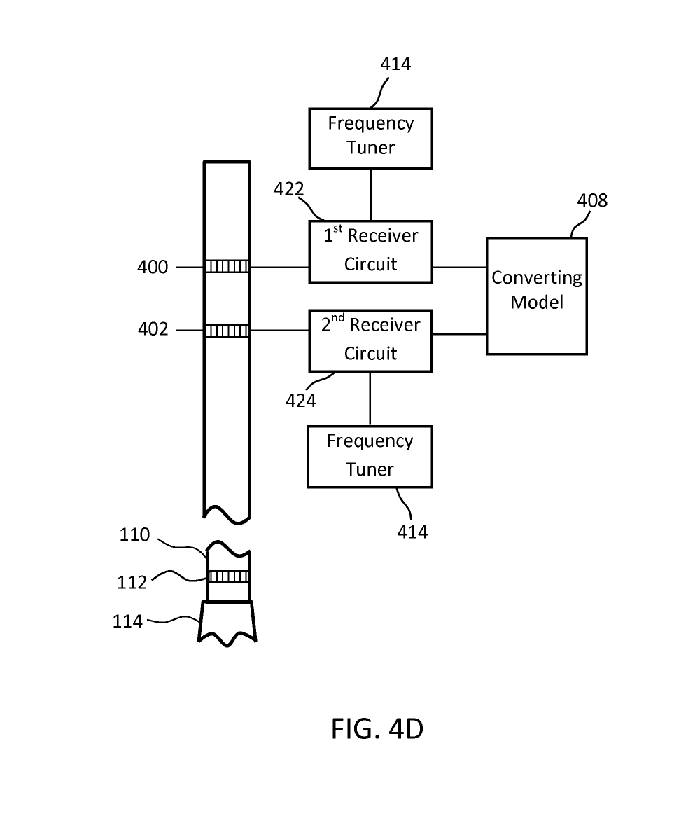

FIG. 4A illustrates a perspective view of a telemetry transmitter 112 and a pair of toroidal receiving antennas (a first toroidal receiving antenna 400 and a second toroidal receiving antenna 402) coupled with a pair of receiver modules (a first receiver module 404 and a second receiver module 406) and a converting module 408 for formation resistivity measurements according to some embodiments of the present invention. The telemetry transmitter 112 is preferably a pre-existing short hop communication transmitter installed in the at-bit sensor unit 110 near the drill bit 114. The telemetry transmitter 112 can be shaped as a toroid, which is able to transmit/receive communication signals including electromagnetic and electrical signals and induce electrical signals as an axial current on the drill collar 102 for measuring environmental conditions to obtain information in regards to desired drill bit and/or motor parameters. The pair of toroidal receiving antennas 400 and 402 can be shaped as toroids and spaced at axial distance from each other, which are able to receive/transmit electromagnetic signals and measure electrical signals from the telemetry transmitter 112. The measured electrical signals are then processed by the pair of receiver modules 404 and 406 and the converting module 408 to calculate the resistivity of surrounding formation and/or other parameters for optimizing drilling operation.

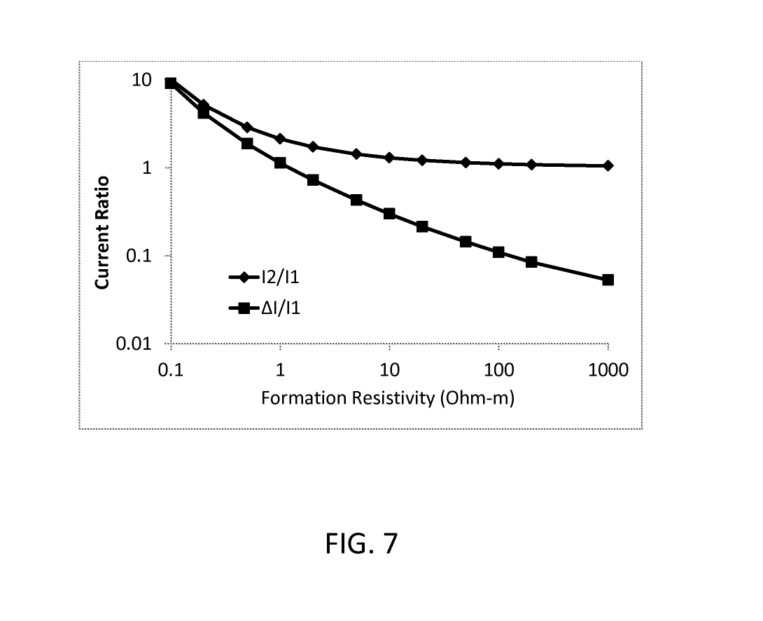

Reference to FIG. 4, when the telemetry transmitter 112 energizes, it will generate an axial current propagating up along the drill collar 102. The axial current propagating along the drill collar 102 can be measured at the first and the second toroidal receiving antennas 400 and 402 respectively. The ratios of the axial currents measured at the first toroidal receiving antenna 400 and the second toroidal receiving antenna 402 can be calculated according to the equation (1) shown below and indicate the relative current flowing into the surrounding formation between the first and the second toroidal receiving antennas 400 and 402.

$$\{ \begin{matrix}{I}_{ratio} = \frac{{I}_{2}}{{I}_{1}} \\ {I}_{relative - ratio} = \frac{{I}_{2} - {I}_{1}}{{I}_{1}}\end{matrix} \qquad ( 1 )$$

where I₁ is the current measured at the first toroidal receiving antenna 400; I₂ is the current measured at the second toroidal receiving antenna 402. The modeled results demonstrate that the ratio Iᵣₐₜᵢₒ or Iᵣₑₗₐₜᵢᵥₑ₋ᵣₐₜᵢₒ defined in Equation (1) is a decreasing functions of the surrounding formation resistivity between the telemetry transmitter 112 and the first and second toroidal receiving antennas 400 and 402. This phenomenon will be further discussed with FIG. 7. Accordingly, the formation resistivity can be determined by a multi-dimensional look-up table that is pre-calculated using electromagnetic forward modeling software. The multi-dimensional look-up table involves at least the formation resistivity, signal frequency, transmitter-receiver distance, and measured current ratios Iᵣₐₜᵢₒ and Iᵣₑₗₐₜᵢᵥₑ₋ᵣₐₜᵢₒ by the receivers 402 and 400. In this way the formation resistivity can still be determined even without any knowledge of the excitation voltage to the toroidal transmitter at bit.

FIG. 4B illustrates a block diagram of illustrative electronics for the first receiver module 404 according to some embodiments of the present invention. The first receiver module 404, which can be coupled to the first toroidal receiving antenna 400, can include at least three sub-modules: an electromagnetic module 410, an electrical module 412, and a frequency tuner 414. The second receiver module 406, which can be coupled to the second toroidal receiving antenna 402, can have the same sub-modules design as the first receiver module 404 can.

The electrical module 412 can include an electrical corresponding circuitry configured to process electrical signals to or from the telemetry transmitter 112 for the formation resistivity measurement. The electromagnetic module 410 can include an electromagnetic corresponding circuitry configured to process electromagnetic signals to or from the telemetry transmitter 112 for gathering other information in regards to environmental conditions near the drill bit 114.

While the pair of toroidal receiving antennas 400 and 402 work with the telemetry transmitter 112, which is a pre-existing short hop communication transmitter, the first and second toroidal receiving antennas 400 and 402 are acting as source-free listeners. However, the frequency of the telemetry transmitter 112 works at may change from job to job. Therefore, the frequency tuner 414 can be included in the first receiver module 404 and the second receiver module 406 to adjust the corresponding circuitry of the first receiver module 404 and the second receiver module 406 to work at the frequency directed by an operator at surface.

FIG. 4C illustrates a block diagram of illustrative electronics for the converting module 408 according to some embodiments of the present invention. The converting module 408 can include at least three sub-components: a storage device 416, a microprocessor 418, and a telemetry module 420. The converting module 408 can be coupled to or embedded in the first and the second receiver modules 404 and 406. The telemetry module 420 can include a telemetry corresponding circuitry to communicate signals with the operator(s) at surface. For example, the information of adequate frequency, which the first and second toroidal receiving antennas 400 and 402 shall work at to match the frequency of the pre-existing telemetry transmitter 112, can be received by the telemetry module 420 and processed by the microprocessor 418, which then can control the frequency tuner 414 to adjust frequency.

In some embodiments, the frequency tuners 414 can be coupled to an existing first receiver circuit 422 and an existing second receiver circuit 424 for frequency adjustment as shown in FIG. 4D. In FIG. 4D, the first receiver circuit 422 can be coupled to the first toroidal receiving antenna 400, and the existing second receiver circuit 424 can be coupled to the second toroidal receiving antenna 402. The existing receiver circuits 422 and 424 can process electrical signals and electromagnetic signals at the frequency controlled by the frequency tuners 414.

Since the telemetry transmitter 112 and the pair of toroidal receiving antennas 400 and 402 are separated at least by a mud motor 108, the spacing between them may change from job to job. Therefore, a multiple dimensional conversion chart can be pre-built in the converting module 408. The multiple dimensional conversion chart can at least include information of (1) formation resistivity; (2) signal frequency; (3) the spacing between the telemetry transmitter 112 and the pair of toroidal receiving antennas 400 and 402; and (4) measured flow-out current through formation between the pair of toroidal receiving antennas 400 and 402, and be stored in the storage device 416. While electrical signals received from the telemetry transmitter 112, the microprocessor 418 can efficiently determine the formation resistivity according to both the data transmitted from the first and second receiver modules 404 and 406 or the first and the second receiver circuits 422 and 424 and the pre-built multiple dimensional conversion chart.

In some embodiments, the dimension of the signal frequency can cover whole frequency band that is practical for the telemetry transmitter 112 to operate.

In some embodiments, the dimension of the spacing between the telemetry transmitter 112 and the pair of toroidal receiving antennas 400 and 402 can cover the distance from the drill bit 114 to the LWD sensor system 106 of a conventional bottom hole drilling assembly as a part of a drilling string.

In some embodiments, the dimension of the formation resistivity can cover the resistivity range of interest, for example, 0.1 to 10000 Ohm-m.

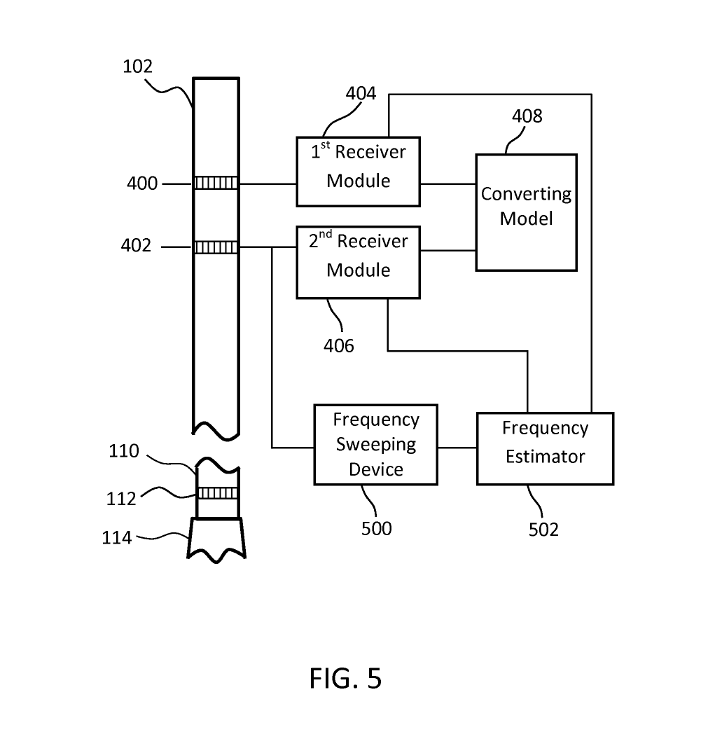

FIG. 5 illustrates a perspective view of a pre-existing telemetry transmitter 112 and a pair of toroidal receiving antennas 400 and 402 coupled with a pair of receiver modules 404 and 406, a converting module 408, a frequency sweeping device 500, and a frequency estimator 502, for formation resistivity measurements according to another embodiment of the present invention. Instead of inputting information of frequency by the operator at surface, this alternative embodiment can further include a frequency sweeping device 500 and a frequency estimator 502 to automatically find out the transmitting frequency from the telemetry transmitter 112.

The frequency sweeping device 500 can be coupled to a transmission link between the second toroidal receiving antenna 402 and the second receiver module 406 to determine the frequency spectrum in an operable frequency band of the telemetry transmitter 112. Then, the frequency estimator 502 can choose the frequency that shoots up the spectrum. Finally, the information of selected frequency by the frequency estimator 502 can be sent to the first and second receiver modules 404 and 406 to guide the frequency tuners 414 to make frequency adjustment.

In some embodiments, the frequency sweeping device 500 can include a frequency sweeping corresponding circuitry configured to read the magnitude of signals in a series of frequencies in an operable frequency band.

In some embodiments, the frequency estimator 502 can include a frequency estimator corresponding circuitry configured to identify the frequency with a maximum magnitude among a series of frequencies.

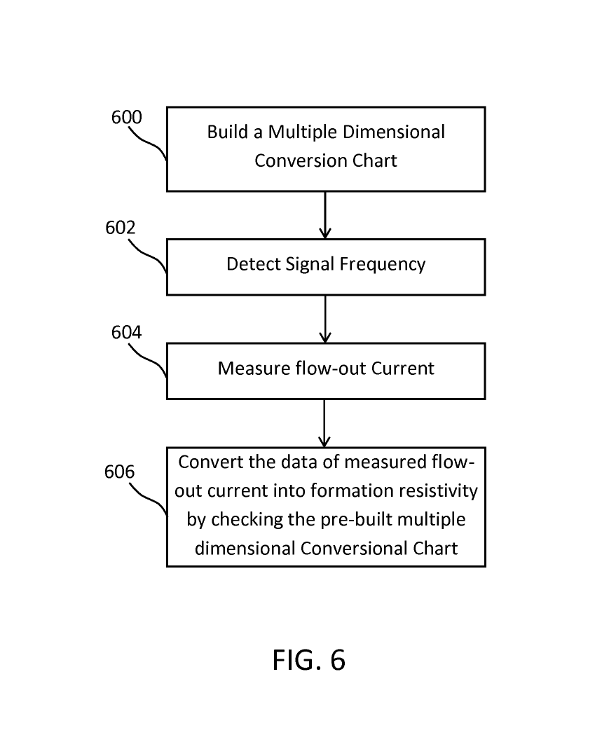

FIG. 6 illustrates a flow chart of utilizing a multiple dimensional conversion chart to convert data inputted into the formation resistivity according to some embodiments of the present invention. The method of converting a data of measured flow-out current through the formation into a data of formation resistivity includes building a multiple dimensional conversion chart 600, which includes dimensions of a signal frequency, a spacing between the telemetry transmitter 112 and the pair of toroidal receiving antennas 400 and 402, a formation resistivity, and a flow-out current through formation between the telemetry transmitter 112 and first and the second toroidal receiving antennas 400 and 402, detecting the signal frequency 602, measuring the flow-out current 604 between the telemetry transmitter 112 and the first and the second toroidal receiving antennas 400 and 402, and converting the data of measured flow-out current into the data of formation resistivity by checking the pre-built multiple dimensional conversion chart 606.

In some embodiments, the step of receiving the signal frequency 602 includes receiving the signal frequency from an operator at surface.

In some embodiments, the step of receiving the signal frequency 602 includes receiving the signal frequency from a frequency estimator 502, which determines frequency according to a transmitting frequency spectrum in an operable frequency band of the telemetry transmitter 112.

In some embodiments, the step of measuring the flow-out current 604 includes subtracting measured current at the first toroidal receiving antenna 400 from the second toroidal receiving antenna 402.

In some embodiments, converting the data of measured flow-out current into the data of formation resistivity includes gathering information of the measured flow-out current, the signal frequency, and the spacing between the telemetry transmitter 112 and the pair of toroidal receiving antennas 400 and 402 to compute the data of formation resistivity.

FIG. 7 illustrates modeling results in term of a data graph of current ratio versus formation resistivity. These modeling results are bases of the multiple dimensional conversion chart. Forward modeling software, such as HFSS and COMSOL, can model the electrical signal responses at toroidal receiving antennas 400 and 402 to the variation of surrounding formation resistivity based on calculation results of electrical fields near the telemetry transmitter 112 and the toroidal receiving antennas 400 and 402 according to Maxwell's equations. Parameters, such as signal frequency and spacing between the telemetry transmitter 112 and the toroidal receiving antennas 400 and 402, can also be considered in the modeling.

In FIG. 7, the current ratio and the relative current ratio, as indicated in Equations (3) and (4) below, vary with formation resistivity. Accordingly, by checking the pre-built multiple dimensional conversion chart with the modeling results, the surrounding formation resistivity can be deduced based on the data of measured I₁ and I₂ at the first and the second toroidal receiving antennas 400 and 402.

$$\begin{matrix}{I}_{ratio} = \frac{{I}_{2}}{{I}_{1}} & ( 3 ) \\ {I}_{relative - ratio} = \frac{{I}_{2} - {I}_{1}}{{I}_{1}} & ( 4 )\end{matrix}$$

In conclusion, exemplary embodiments of the present invention stated above may provide several advantages as follows. The present invention can utilize a pre-existing sensor as an electromagnetic and electrical signal transmitter located near a drill bit for measurements of environmental conditions of formation around a drill bit and surrounding formation resistivity. Furthermore, the present invention can provide components to adjust working frequency of receivers. Finally, a pre-built multiple dimensional conversion chart can help users to efficiently compute the formation resistivity according to information of signal frequency, spacing between the transmitter and the receiver, and measured flow-out current through surrounding formation.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus for utilizing a pre-existing telemetry transmitter mounted on a drilling string and positioned below a mud motor and near a drill bit for transmitting or receiving signals to make measurements of surrounding resistivity conditions comprising:
a drill collar;
at least two toroidal receiving antennas deployed on the drill collar and spaced at an axial distance from each other for receiving or transmitting the signals from or to the telemetry transmitter; wherein the signals include difference between electrical signals measured at the two toroidal receiving antennas;
at least two receiver modules coupled to the toroidal receiving antennas; wherein the receiver modules include electrical modules for processing the signals received or to be transmitted from or to the telemetry transmitter and frequency tuners to adjust frequency the receiver modules work at;
a converting module coupled to the receiver modules; and
wherein the converting module includes a microprocessor for calculating surrounding formation resistivity and controlling the frequency tuners in the receiver modules.

2. The apparatus according to claim 1 wherein the signals are electrical signals or electromagnetic signals.

3. The apparatus according to claim 2 wherein the electrical signals comprise an axial current on the drill collar.

4. The apparatus according to claim 1 wherein the electrical module comprises an electrical corresponding circuitry configured to process the signals from or to the telemetry transmitter and relays the signals to the microprocessor in the converting module for calculating the surrounding formation resistivity.

5. The apparatus according to claim 1 wherein the converting module comprises a telemetry module with a telemetry corresponding circuitry to communicate with an operator at surface.

6. The apparatus according to claim 5 wherein the operator at surface transmits signals about frequency information for matching the frequency of the telemetry transmitter, via the telemetry module to direct the frequency tuner to adjust frequency the receiver modules work at.

7. The apparatus according to claim 1 further comprises a frequency sweeping device coupled to a transmission link between the toroidal receiving antenna and the receiver module, and a frequency estimator coupled to the frequency sweeping device.

8. The apparatus according to claim 7 wherein the frequency sweeping device comprises a frequency sweeping corresponding circuitry configured to determine the frequency spectrum in an operable frequency band of the telemetry transmitter by reading the magnitude of signals in a series of frequencies.

9. The apparatus according to claim 8 wherein the frequency estimator comprises a frequency estimator corresponding circuitry configured to choose frequency from the frequency spectrum by identifying the frequency with a maximum magnitude among a series of frequencies.

10. The apparatus according to claim 1 wherein the receiver modules comprise electromagnetic modules including electromagnetic corresponding circuitry configured to process the signals to or from the telemetry transmitter for gathering information of environmental conditions except for the surrounding formation resistivity.

11. The apparatus according to claim 1 wherein the converting module comprises a storage device.

12. The apparatus according to claim 11 wherein the storage device is stored with a multiple dimensional conversion chart with dimensions of the formation resistivity, a signal frequency, a spacing between the telemetry transmitter and the pair of toroidal receiving antennas, and measured signals for computing the surrounding formation resistivity according to the inputted data of the signal frequency, the spacing between the telemetry transmitter and the pair of toroidal receiving antennas, and the measured signals.

13. The apparatus according to claim 12 wherein the measured signals are measured flow-out current through the formation between the two toroidal receiving antennas, which is equal to the difference in axial current measured at the two toroidal receiving antennas.

14. The apparatus according to claim 12 wherein the bandwidth of the signal frequency of the toroidal receiving antenna covers whole frequency band that is practical for the telemetry transmitter to operate.

15. The method for utilizing a multiple dimensional conversion chart to convert a data of measured flow-out current through the formation into a data of formation resistivity on an apparatus with a telemetry transmitter and a pair of toroidal receiving antennas comprises:
building a multiple dimensional conversion chart; wherein the multiple dimensional conversion chart includes signal frequencies, a spacing between the telemetry transmitter and the pair of toroidal receiving antennas, a formation resistivity, and a flow-out current through formation between the two toroidal receiving antennas;
detecting the signal frequency; measuring the flow-out current through formation between the two toroidal receiving antennas; and
converting the data of measured flow-out current into the data of formation resistivity by checking the pre-built multiple dimensional conversion chart.

16. The method according to claim 15 wherein the receiving signal frequency comprises receiving the signal frequency from an operator at surface.

17. The method according to claim 15 wherein the receiving signal frequency comprises receiving the signal frequency from a frequency estimator, which determines frequency according to a transmitting frequency spectrum in an operable frequency band of the telemetry transmitter.

18. The method according to claim 15 wherein the measuring the flow-out current comprises calculating the difference in axial current measured at the two toroidal receiving antennas.

19. The method according to claim 15 wherein the converting the data of measured flow-out current into the data of formation resistivity comprises gathering information of the measured flow-out current, the signal frequency, and the spacing between the telemetry transmitter and the pair of toroidal receiving antennas to compute the data of formation resistivity.

20. An apparatus for making measurements of surrounding formation resistivity comprising:
a drill collar;
a telemetry transmitter deployed on the drill collar for transmitting or receiving signals;
at least two toroidal receiving antennas deployed on the drill collar for receiving or transmitting the signals from or to the telemetry transmitter; wherein the signals include difference between electrical signals measured at the two toroidal receiving antennas;
at least two receiver circuits coupled to the toroidal receiving antennas;
at least two frequency tuners coupled to the receiver circuits to adjust frequency which the receiver circuits work at; and
a converting module coupled to the receiver circuits for calculating the surrounding formation resistivity, controlling the frequency tuners, and being stored with a multiple dimensional conversion chart for computing the surrounding formation resistivity.
